(19) United States
(12) Patent Application Publication
(10) Pub. No.: US 2011/0246878 A1
(43) Pub. Date: Oct. 6, 2011

(54) SYSTEM, APPARATUS AND METHOD FOR FACILITATING TATTOO APPLICATIONS

(76) Inventor: SEAN DOWDELL, TEMPE, AZ (US)

(21) Appl. No.: 13/075,758

(22) Filed: Mar. 30, 2011

Related U.S. Application Data
(60) Provisional application No. 61/319,711, filed on Mar. 31, 2010.

(51) Int. Cl. G06F 3/048

(52) U.S. Cl. 715/702; 715/773; 715/764; 715/810

(57) ABSTRACT

A user computer system, computer-implemented method, and kiosk for providing a number of tattoo designs that satisfy search criteria entered in by a user through an easy-to-use interface. In an illustrative embodiment, a user computer system having a touch screen, a graphical user interface (GUI), and an interactive viewer is provided. The user computer system can receive input using the interactive viewer through the touch screen. Thereafter, the user computer system can identify at least one tattoo design from a database using the input. Typically, the system can use a matching algorithm known to those skilled in the art. After at least one tattoo design is retrieved from the database, the system can display the at least one tattoo design on the interactive viewer through the GUI. In one embodiment, the user can enter in text with the system displaying the text in a number of different fonts.

### REFERENCE TO RELATED APPLICATIONS

This application claims priority to U.S. Provisional Application Ser. No. 61/319,711 titled SYSTEM, APPARATUS AND METHOD FOR FACILITATING TATTOO APPLICATIONS that was filed on Mar. 31, 2010 by Sean Dowdell, which is hereby incorporated by reference in its entirety.

### TECHNICAL FIELD

This disclosure generally relates to tattoos, and more particularly, to a system, apparatus and method for providing a number of tattoo designs to an individual through a graphical user interface.

### BACKGROUND

Tattooing has been performed for many centuries among numerous countries. Tattoos are made by inserting ink into layers of skin changing the pigment of the skin. The most common method of tattooing involves an electric machine that inserts ink into the skin via a group of needles that are soldered onto a bar, which is attached to an oscillating unit. The unit itself rapidly and repeatedly drives the needles in and out of the skin.

Because tattoos are generally permanent, selecting an appropriate tattoo is desirable. Tattoo parlors often display their artwork on their walls to provide patrons with ideas for their tattoo. Parlors also maintain a series of tattoo photos that can be bound in a book. Alternatively, the patron can provide them with a description of what type of tattoo they are looking for so that a customize tattoo can be etched.

Nevertheless, these methods for selecting an appropriate tattoo have not kept up with today's technology. For example, most artwork provided within tattoo parlors is local. Furthermore, the number of designs that a user can choose from is very limited. A need therefore exists for a system, apparatus and method whereby the patron can access a number of designs while overcoming the above-described limitations.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present disclosure, a user computer system having a touch screen, a GUI provided on said touch screen, and an interactive viewer displayed through said GUI for determining an appropriate tattoo for an individual is provided. The system can include a database for storing tattoo designs. In addition, the system can include at least one processor. The system can also include a memory operatively coupled to the processor, the memory storing program instructions that when executed by the processor, causes the processor to perform processes. The processes can include receiving input using the interactive viewer through the touch screen. In addition, the processes can include identifying at least one tattoo design from the database using the input. The processes can also include displaying the at least one tattoo design on the interactive viewer through the GUI and receiving a selection to print the at least one tattoo design. The processes can include printing the at least one tattoo design.

In accordance with another aspect of the present disclosure, a computer-implemented method for providing tattoo designs is provided. The method can include displaying a virtual keyboard and receiving at least one character from the virtual keyboard. In addition, the method can include converting the at least one character into multiple fonts and displaying the at least one character in the multiple fonts. The method can also include receiving a selected font for the at least one character from the multiple fonts and printing the at least one character in the selected font as a tattoo design.

In accordance with yet another aspect of the present disclosure, a kiosk for facilitating tattoo applications is provided. The kiosk can include a terminal display that provides visual software. In addition, the kiosk can include a data repository that stores, maintains, and delivers a plurality of tattoo designs for display on the terminal display, wherein displaying the plurality of tattoo designs provide a customer with control over a selection and design of their tattoo.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a block diagram that shows illustrative components of an interactive tattoo viewer in accordance with one aspect of the present disclosure;

FIG. 2 depicts an exemplary flow chart that shows processes for a text editor in accordance with one aspect of the present disclosure;

FIG. 3 provides a block diagram that depicts components of a digital flash catalog in accordance with one aspect of the present disclosure;

FIG. 4A represents a typical block diagram for loading and displaying an alpha-menu in accordance with one aspect of the present disclosure;

FIG. 4B is an exemplary block diagram for displaying a category menu in accordance with one aspect of the present disclosure;

FIG. 4C represents a block diagram showing illustrative processes for displaying a sub-category menu in accordance with one aspect of the present disclosure;

FIG. 4D shows a block diagram illustrating exemplary processes for displaying content in accordance with one aspect of the present disclosure; and

FIG. 5 depicts an exemplary hardware and software environment in which tattoo designs can be distributed in accordance with one aspect of the present disclosure.

### DESCRIPTION OF THE APPLICATION

The description set forth below in connection with the appended drawings is intended as a description of presently preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

### System Overview

Generally described, the present disclosure relates to an interactive tattoo viewer. More specifically, the present disclosure relates to providing a number of tattoo designs that satisfy search criteria that are entered into an easy-to-use interface. In an illustrative embodiment, a user computer system having a touch screen, a graphical user interface (GUI), and an interactive viewer is provided. The user computer system can receive input using the interactive viewer through the touch screen. Thereafter, the user computer system can identify at least one tattoo design from a database using the input. Typically, the system can use a matching algorithm known to those skilled in the art. After at least one tattoo design is retrieved from the database, the system can display the at least one tattoo design on the interactive viewer through the GUI.

As will become apparent, the system described above can be a very powerful sales tool. Generally, the system can allow the customer to be more integrated into the selection and design process, often resulting in much more complex designs than what would come from a static flashboard selection. Having this system strategically placed in the store can enable the artists to engage the customers to offer advice and ultimately close the sale.

As will be shown below, the system can come in a variety of forms. For example, the system can be implemented as a standalone kiosk. Alternatively, the system can be run on top of a personal computer. In another embodiment, the system can be provided on a single flat screen device that can run software programs. The system can also be provided on software that can interact with a remote service such as those found over the Internet. One skilled in the relevant art will appreciate that there are numerous types of implementations. Many additional features and elements of the present disclosure will become apparent to one of ordinary skill in the art in the following description.

### Viewer

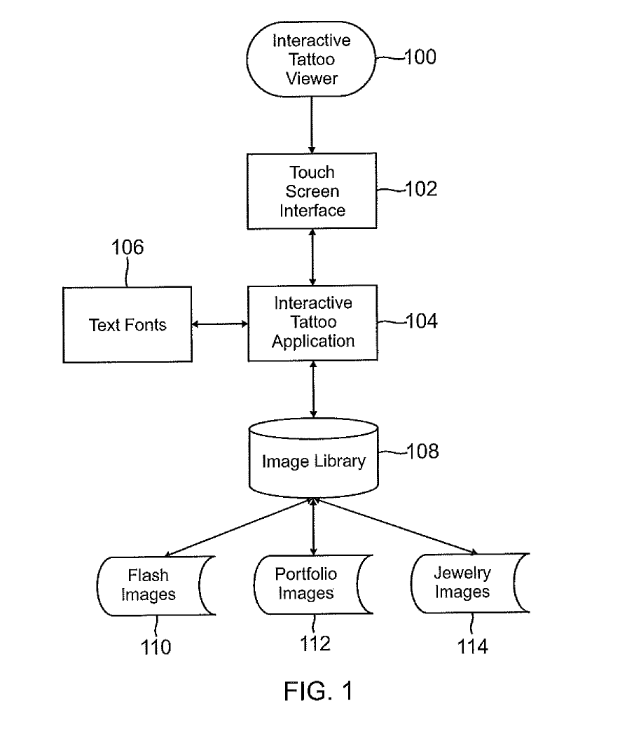

With reference now to FIG. 1, a block diagram that shows illustrative components of an interactive tattoo viewer 100 in accordance with one aspect of the present disclosure is provided. Generally speaking, the viewer 100 can keep track of tattoo design ideas in a digital format to later provide them to requesting parties. The designs can be formatted and uploaded in a specific size, for example, ten (10) inches.

As shown at block 102, the viewer 100 can include a touch screen interface. In typical touch screens, the user can make contact with the display using their finger, hand, stylus, pointer, etc. to provide input to the system. In other embodiments of the viewer 100, a touch screen interface is not used. Instead, input can be provided through devices that include a mouse, keyboard, voice activation, etc.

At block 104, an interactive tattoo application can be provided on the screen, which, as shown before, can act as an input device. The application, in combination with the screen, can be provided in a standalone unit. The interactive tattoo application can interact with text fonts at block 106. As will be shown below, the text fonts can be used with the text editor feature.

At block 108, the interactive tattoo application can interact with an image library. The image library can be associated with flash images at block 110, portfolio images at black 112, and jewelry images at block 114. Those skilled in the relevant art will appreciate that there are numerous types of images that can be stored in the image library, and those shown represent only a small sample of images.

### Functions and Features

Operatively, the interactive tattoo viewer 100 provides a number of functions and features. In one embodiment, the viewer 100 can be designed to look like a well spaced alphabet. The letters of the alphabet are placed along the sides of the screen. After deciding the type of tattoo the user wants, the user can select a letter that the subject of their tattoo starts with. For example, when the user is looking for flowers, the user can start by selecting “F”. In turn, categories that start with “F” are provided in a drop down menu. The user can then select any appropriate sub-categories.

The background of the viewer 100 can be customized to allow a purchaser to have the designed look of customized software for their specific business. In one embodiment, the viewer 100 can partition a section at the top of the screen. This partition can allow users to search through a portfolio of work by specific artists, or photos of other art or photographs or general information.

To track images stored within the viewer 100, category identification numbers can be assigned to each tattoo design. The designs can be categorized by a series of different characters including numeric and alphabetic. Identification numbers can be tracked making a tattoo design easier to locate internally. The assigned category identification numbers can be located on a separate computer file to be printed from the library of designs. The numbers can be modified by the tattoo artist to meet the customer requests. A matching algorithm can be used to locate the images. The matching algorithm can use the identification numbers or other search criteria to locate the images. For example, keyword searches can be performed.

In typical embodiments, the viewer 100 keeps the individual designs categorized into different folders that make it easy to narrow topics or styles of the designs. For example, a folder can be labeled animals. When the folder is selected, the animal folder can be broken down into animal subcategories such as lions, tigers, and bears so that the user can find exactly what they are looking for within a few seconds.

The viewer 100 can also allow one design to be placed in multiple categories. The user can keep track of their favorites using a clipboard. In one embodiment, the user can store their favorite designs in a folder at the bottom of the screen as they continue to browse other designs. The selections can appear until the client has purposely cleared the screen. Click-and-drag techniques can be used.

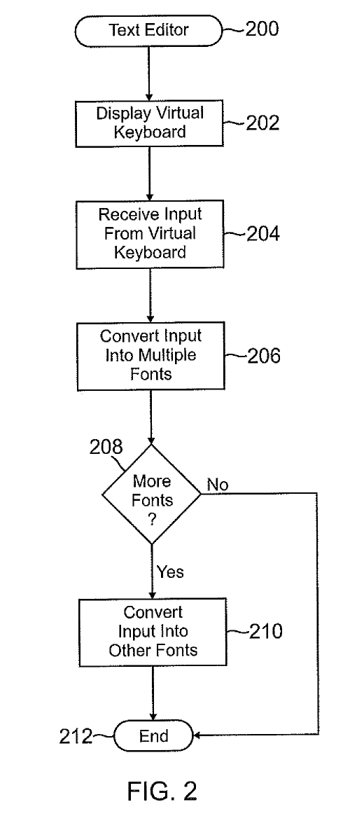

A text editor can also be provided. FIG. 2 depicts an exemplary flow chart that shows processes for the text editor in accordance with one aspect of the present disclosure. The processes provided below are not to be construed as limiting, but instead represent an exemplary set of processes. The processes can begin at block 200.

At block 202, the interactive tattoo viewer 100 can display a virtual keyboard, which can be provided on the touch screen interface described above. The virtual keyboard can include a layout that can be found on most typical keyboards. When a key is selected on the virtual keyboard, the specific key can simulate a motion that it has been pressed. For example, a graphical icon can show the key going up and down.

At block 204, the interactive tattoo viewer 100 can receive input from the virtual keyboard. The input can be in the form of a number, letter, or any other type of character. Other characters that are not found on a typical keyboard can also be received from the user. The characters can then be converted into multiple fonts at block 206. As previously shown, text fonts can be received at block 106. The characters that have been converted can then be displayed.

Generally, the interactive tattoo viewer 100 can be used to display the characters in a predetermined number of fonts. At decision block 208, the viewer 100 can determine whether the user wishes to convert the characters into additional fonts. When additional fonts are requested, the interactive tattoo viewer 100 can convert the characters into other fonts at block 210. A scrollable interface can be provided such that the additional fonts are shown. The processes can end at block 212.

While text and fonts were described above, other types of graphics, illustrations, pictures, etc. can be incorporated within the interactive tattoo viewer 100. The user can modify the combination of text, fonts and graphics through the viewer 100.

In one embodiment, the interactive tattoo viewer 100 can incorporate multiple languages, for example, Spanish, English, Italian, French, Portuguese, Japanese, etc. This multi-language user function can be provided through one touch on the touch screen interface. The viewer 100 can also incorporate a spelling dictionary for not only English text, but as well as other languages.

### Digital Flash Catalog

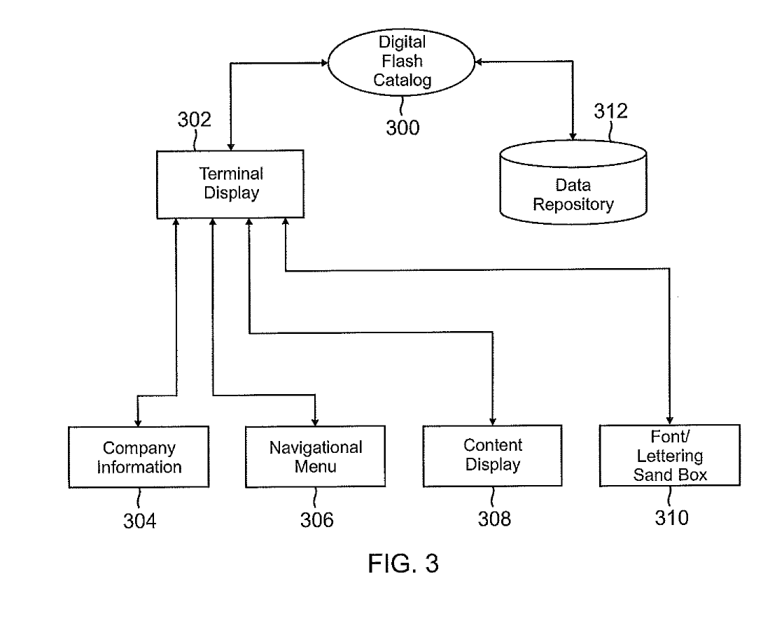

Internally, the interactive tattoo viewer 100 provides a digital flash catalog 300 as shown in FIG. 3. The digital flash catalog 300 can be a program that runs by itself or at any other location. In one embodiment, the catalog 300 can be provided on a website. This can allow users to browse company products and services via a physical and virtual terminal. In another embodiment, the catalog 300 can be run atop a cloud whereby shared resources, software and information are provided to the catalog 300. Those skilled in the relevant art will appreciate that there are a number of implementations that allow a user to search for tattoo designs and retrieve them from a variety of locations.

With further reference to FIG. 3, the digital flash catalog 300 can be made up of at least two components: the terminal display 302 and the data repository 312. The terminal display 302 can be the visual software located on each physical and virtual terminal while the data repository 312 can be a system that stores, maintains, and delivers the content displayed within the terminal display 302.

With respect to the terminal display 302, the visual presentation running thereon can be customizable for a specific user. For example, some displays 302 appeal to females while others appeal to males. The data repository 312 can be modified by the user in one embodiment. The user through the interactive tattoo viewer 100 can add file images and categorize them how they feel it would be best within the viewer 100. Those skilled in the relevant art will appreciate that there is typically no set standard as this would impose unnecessary restrictions on the user.

### Terminal Display

The terminal display 302 can be an interactive and transparent program executed from either a physical or virtual terminal. The terminal display 302 can be the software that is used to browse through company products and services and can be made up of four different components. These components can include company information 304, navigational menu 306, content display 308, and font/lettering sandbox 310. Through the use of the terminal display 302, the customer can easily browse through products and services and test different fonts/lettering for custom projects. Details and features for each of these components will be discussed below.

The company information component 304 of the terminal display 302 can encompass company specific information that is transparent to the end user. This information can include, but is not limited to titles, logos, and color scheme. One function of the company information component 304 is the ability to brand and white label the terminal display 302 for multiple company/brand support. The terminal display 302 can be easily manipulated to display alternative company information via manipulation of the title, company logos, and color scheme.

The navigational menu component 306, which forms a part of the terminal display 302, can allow the user to browse through different categories of products and services. The navigational menu component 306 can include an alphabetic menu, category menu, and alternative function menu. Each menu will be described in more details below.

In typical embodiments, the navigational menu 306 can display information through alphabetical categories. For example, airplanes can be categorized as “A=>Airplanes”. Some categories are categories of other categories and are available to the user through the category menu. For example: “Bi-Planes” is a category of “A” and “Airplanes” and is categorized as “A=>Airplanes=>Bi-Planes”.

The alphabetical menu can include a single button for each letter of the alphabet. These buttons can be displayed on the left and right sides of the terminal display 302. In one embodiment, letter buttons “A” through “M” are displayed on the left side of the display 302, while letter buttons “N” through “Z” are displayed on the right side. When selected, each button can execute and display a corresponding category menu.

The category menu can be a text menu that includes textual categories displayed as buttons. The category menu can include categories that begin with the letter selected above. The user can scroll through the different categories. Each category can include one to many different textual buttons defining each category. The category buttons can also include sub-categories that in turn can include one to many different sub-categories. Upon clicking on or touching a category text button that includes sub-categories an additional category menu can be displayed. Through the use of the alphabetic menu and the category menu, the user can execute the content display to start browsing through products and services offered through the digital flash catalog 300.

In one embodiment, an alternative function menu can be provided. The alternative function menu can be separate from the alphabetic menu and can include separate buttons that execute specific functions. The alternative function menu can provide artist and piercer portfolios. Furthermore, the menu can provide the execution of the font/lettering sandbox component 310, which will be described in more details below.

The content display component 308 can be the portion of the terminal display 302 that provides product thumbnail content to the user. The content display component 308 can offer one-to-many different thumbnail images of products and services and includes a navigational menu that allows the user to page through thumbnail images. Upon selection of a thumbnail image, product details function can be shown.

An image loader can be a section of the content display 308 that provides thumbnail images of products and services offered. One-to-many different thumbnails are presented to the user through the image loader. The image loader can request image information from the data repository 312 and load pages of content. Furthermore, the image loader can allow the user to page or browse through an entire list of products.

The product detail can be the section of the content display 308 that provides individual product information to the user and is executed via clicking on a thumbnail image from the image loader. The product detail function can display a larger image of the specific product or service chosen by the user and can offer specific product information including but not limited to product ID, price, and general information.

Continuing with FIG. 3, the font/lettering sandbox 310 can be the portion of the terminal display 302 that offers the user a sandbox to test and try out different fonts against a string of characters. The font/lettering sandbox 310 can be made up of three different parts: the lettering display, font chooser, and digital keyboard.

The lettering display can be the portion of the font/lettering sandbox 310 that can display a string of text chosen by the user via typing characters on the digital keyboard. Through the lettering display the user can see a visual representation of the different fonts applied to a defined string of text. The font chooser can be the portion of the font/lettering sandbox 310 that allows the user to choose different fonts to apply to a defined string of text. The font chooser can be presented to the user as a drop down or horizontal menu including the different fonts available for use. Upon selecting a font, the textual representation of the string typed into the lettering display is changed to use the selected font. This can be related to the text editor function described previously.

The digital keyboard can be the portion of the font/lettering sandbox 310 that allows the user to type a string of text into the lettering display. The virtual keyboard can include buttons for each letter of the alphabet, numbers zero (0) through nine (9), special characters, a backspace button, a white space button, and a carriage return button.

### Data Repository

The data repository 312 can be the underlying system that stores, maintains, and delivers the content that is displayed through the terminal display 302. The content, in the form of images and font files, can be stored in a common categorized repository. The software that maintains the repository 312 can build menus and content data and return the data to the terminal display 302 for processing upon request. The data repository 312 can be made up of two different sections: the data file system and the data request system.

The data file system can be a directory structure located on a physical hard drive. Typically, the data file system can include a root directory, typically named content, alpha directories, portfolio directories, and category directories. The directory hierarchy from the root can be as follows: root=>alpha directory=>category directory=>sub-category directory.

The root directory can be the base directory for the content used by the digital flash catalog 300. Within the root directory, there are several other directories including a directory for each letter of the alphabet, i.e. alpha directories, and artist/piercer portfolios. Alpha directories can be named after its corresponding letter of the alphabet; for example, the A directory is named after the letter “A”. The portfolio directories can be stored within a subdirectory of the root directory named “portfolios”. Within the “portfolios” directory each artist and piercer can have their own content directory that is named after the specific artist or piercer.

The alphabetic directory can be a directory that stores category directories for their corresponding letter of the alphabet. For example, the “Airplane” category can be a directory located within the “A” alphabetic directory. Each category directory can store images and/or sub-category directories that belong to that specific category. Each category directory can be named after its specific category. For example, the “Airplanes” category is a category directory within the data file system named “Airplanes” categorized under the “A” alphabetic directory.

Some category directories can also contain sub-categories. Sub-categories are additional category directories stored within their corresponding category directory. For example, the “Bi-Planes” category is a sub-category of the “Airplanes” category and can be stored within the “Airplanes” category directory. The directory structure for a sub-category is as follows: root directory=>Alpha Category Directory=>Category Directory=>Sub-category Directory. Image and content files can be stored within category and sub-category directories. Image and content files can be named after their corresponding product IDs and include a .gif, .jpg, or .png file extension.

The data request system can be a piece of software designed to receive instructions from the terminal display 302, process such instructions, and return XML data to the terminal display 302. The data request system can return alphabetic, category, sub-category, and image/content information in XML format. A matching algorithm can be used to retrieve appropriate graphics, images, pictures, etc. from the data repository 312.

In one embodiment, the English alphabet used for categorizing the tattoos can be interchanged with other languages. For example, Spanish, Italian, French, Portuguese, Japanese, etc. can also be incorporated to find a specific tattoo.

### Terminal Display Operations

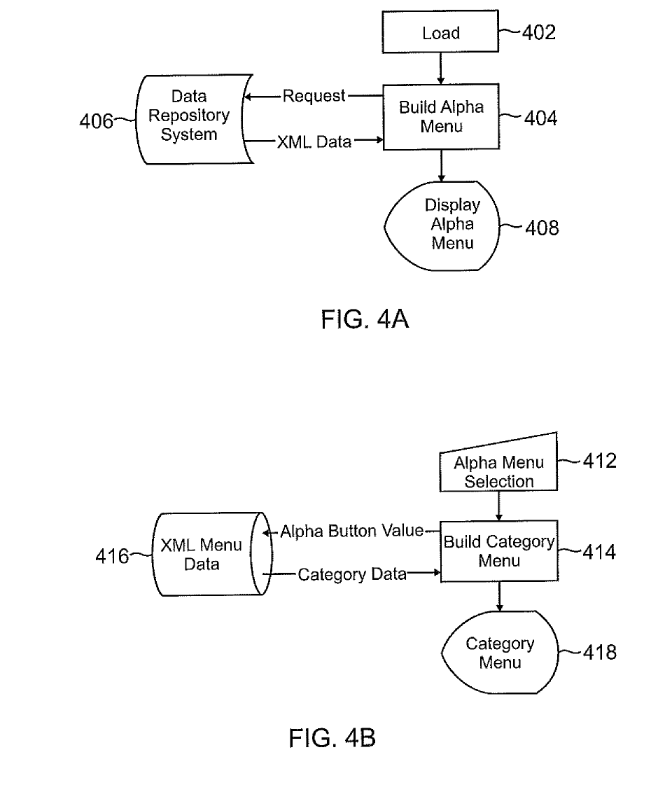

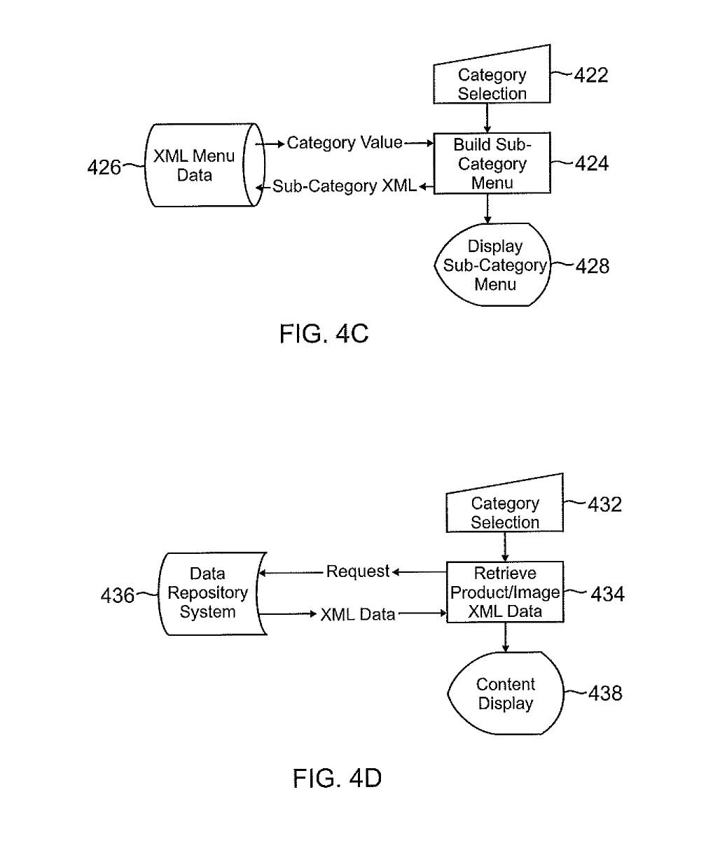

FIG. 4A represents a typical block diagram for loading and displaying an alpha-menu in accordance with one aspect of the present disclosure. Upon execution of the digital flash catalog 300 the program can load the alpha menu at block 402. At block 404, the terminal display 302 can build the alpha menu by interacting with the data repository 312 at block 406. In one embodiment, when building the alpha menu, a request can be sent to the data repository 312. In return, the data repository 312 can send XML data. Those skilled in the relevant art will appreciate that the data repository can format the data in other markup languages.

With reference now to FIG. 4B, an exemplary block diagram for displaying a category menu in accordance with one aspect of the present disclosure is provided. At block 412, the terminal display 302 can wait for an alpha menu selection. When a selection is received by clicking on/touching an alpha button value, a category menu can be built at block 414. The terminal display 302 can request category information from the XML data that was returned upon the alpha menu request and displays a category menu at block 416. At block 418, once the category menu is displayed the system remains dormant and waits for additional user input.

FIG. 4C represents a block diagram showing illustrative processes for displaying a sub-category menu in accordance with one aspect of the present disclosure. At block 422, a sub-category menu can be provided. After the sub-category is selected, a series of processes can be invoked. At block 424, the terminal display 302 can build the sub-category menu. The sub-category data can be pulled from the data repository 312 at block 426. In one embodiment, the terminal display 302 can request for a category value. In turn, sub-category XML data can be provided to the data repository 312 at block 426. At block 428, the sub-category menu can be displayed.

FIG. 4D shows a block diagram illustrating exemplary processes for displaying content in accordance with one aspect of the present disclosure. At block 432, the user can select a category. This causes the terminal display 302 to retrieve product/image XML data at block 434. At block 436, a request is made to the data repository 312. In return, XML data is provided so that the product/image data can be generated. At block 438, the content is displayed.

### Hardware Environment

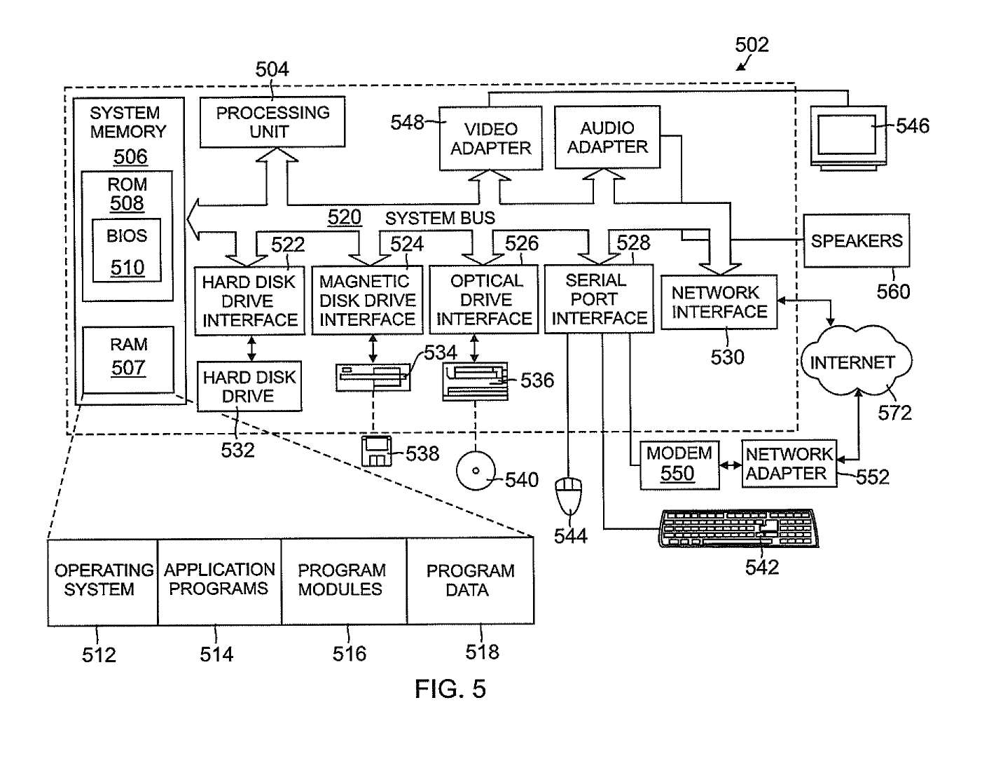

An exemplary hardware and operating environment for implementing the interactive tattoo viewer 100 of the present disclosure can include a general purpose computer 502 as shown in FIG. 5. The components as described below within the computer 502 can generally be found in each. The hardware can include a processing unit 504, a system memory 506, and a system bus 520 that operatively couples various system components, including the system memory 506 to the processing unit 504. There can be only one or there can be more than one processing unit 504, such that the processor of computer 502 comprises a single central processing unit (CPU), or a plurality of processing units, commonly referred to as a parallel processing environment. The computer 502 can be a conventional computer, a distributed computer, a web server, a file server, a self-contained unit, and any other type of computer.

The system bus 520 can be any of several types of bus structures including a memory bus or memory controller, a peripheral bus, a switched fabric, point-to-point connections, and a local bus using any of a variety of bus architectures. The system memory 506 can also be referred to as simply the memory, and includes read only memory (ROM) 508 and random access memory (RAM) 507. A basic input/output system (BOIS) 510, containing the basic routines that help to transfer information between elements within the computer 502, such as during start-up, is stored in ROM 508. The computer 508 further includes a hard disk drive 532 for reading from and writing to a hard disk, not shown, a magnetic disk drive 534 for reading from or writing to a removable magnetic disk 538, and an optical disk drive 536 for reading from or writing to a removable optical disk 540 such as a CD ROM or other optical media.

The hard disk drive 532, magnetic disk drive 534, and optical disk drive 536 can be connected to the system bus 520 by a hard disk drive interface 522, a magnetic disk drive interface 524, and an optical disk drive interface 526, respectively. The drives and their associated computer-readable medium provide nonvolatile storage of computer-readable instructions; data structures, e.g., a catalog and a contextual-based index; program modules, e.g., a web service and an indexing robot; and other data for the computer 502. It should be appreciated by those skilled in the relevant art that any type of computer-readable medium that can store data that is accessible by a computer, for example, magnetic cassettes, flash memory cards, digital video disks, RAM, and ROM, can be used in the exemplary operating environment.

A number of program modules can be stored on the hard disk 532, magnetic disk, optical disk 536, ROM 508, or RAM 507, including an operating system 512, one or more application programs 514, other program modules 516, and program data 518. A user can enter commands and information into the personal computer 502 through input devices such as a keyboard 542 and pointing device 544, for example, a mouse. Other input devices (not shown) can include, for example, a microphone, a joystick, a game pad, a tablet, a touch screen device, a satellite dish, a scanner, a facsimile machine, and a video camera. These and other input devices are often connected to the processing unit 504 through a serial port interface 528 that is coupled to the system bus 520, but can be connected by other interfaces, such as a parallel port, game port or a universal serial bus (USB).

A monitor 546 or other type of display device can also be connected to the system bus 520 via an interface, such as a video adapter 548. The monitor 546 can be in the form of a touch screen device removing the need for any input devices. In addition to the monitor 546, computers typically include other peripheral output devices, such as a printer and speakers 560. The printer can be used to print the tattoo designs or templates. These and other output devices are often connected to the processing unit 504 through the serial port interface 528 that is coupled to the system bus 520, but can be connected by other interfaces, such as a parallel port, game port, or a universal serial bus (USB).

The computer 502 can operate in a networked environment using logical connections to one or more remote computers. These logical connections can be achieved by a communication device coupled to or integral with the computer 502; the application is not limited to a particular type of communications device. The remote computer can be another computer, a server, a router, a network personal computer, a client, a peer device, or other common network node, and typically includes many or all of the elements described above relative to the computer 502, although only a memory storage device has been illustrated in FIG. 5. Computer 502 can be logically connected to the interne 572. The logical connections can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet, which are all types of networks.

When used in a LAN environment, the computer 502 can be connected to the local network through a network interface or adapter 530, which is one type of communication device. When used in a WAN environment, the computer 502 typically includes a modem 550, a network adapter 552, or any other type of communications device for establishing communications over the WAN. The modem 550, which can be internal or external, is connected to the system bus 520 via the serial port interface 528. In a networked environment, program modules depicted relative to the personal computer 502, or portions thereof, can be stored in a remote memory storage device. It is appreciated that the network connections shown are exemplary and other means of and communications devices for establishing a communications link between the computers can be used.

The technology described herein can be implemented as logical operations and/or modules in one or more systems. The logical operations can be implemented as a sequence of processor-implemented steps executing in one or more computer systems and as interconnected machine or circuit modules within one or more computer systems. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. Furthermore, it should be understood that logical operations can be performed in any order, unless explicitly claimed otherwise or a specific order is inherently necessitated by the claim language.

Computer 502, as described above, was exemplary and should not be construed as limiting. Computer 502 typically encompasses many types of other devices. Such devices can include a cell phone, personal digital assistant (PDA), stationary personal computer, IPTV remote control, web tablet, laptop computer, pocket PC, a television set capable of receiving IP based video services and mobile IP device, etc.

### Systems, Methods and Operations

The aspects described below represent embodiments of the present disclosure. Nevertheless, these are not intended to be limiting to the scope defined herein. In accordance with one aspect of the present disclosure, a user computer system having a touch screen, a GUI provided on said touch screen, and an interactive viewer displayed through said GUI for determining an appropriate tattoo for an individual is provided. The system can include a database for storing tattoo designs. In addition, the system can include at least one processor. The system can also include a memory operatively coupled to the processor, the memory storing program instructions that when executed by the processor, causes the processor to perform processes. The processes can include receiving input using the interactive viewer through the touch screen. In addition, the processes can include identifying at least one tattoo design from the database using the input. The processes can also include displaying the at least one tattoo design on the interactive viewer through the GUI and receiving a selection to print the at least one tattoo design. The processes can include printing the at least one tattoo design.

In one embodiment, the tattoo designs can include at least one of an illustration, picture, graphic and lettering. In one embodiment, receiving the input through the touch screen can include obtaining a text along with a font. In one embodiment, displaying the at least one tattoo design can include providing the text in the font on the GUI.

In one embodiment, identifying the at least one tattoo design using the input can include obtaining a category from the user input and searching through the tattoo designs within the database that fit within the category. In one embodiment, the processes can include obtaining a subcategory associated with the category and searching through the tattoo designs within the database that fit within the subcategory.

In one embodiment, the printed tattoo design is provided as a template. The template can be used by a tattoo artist to apply the at least one tattoo design on a user. In one embodiment, the tattoo designs can be stored within the database in categories and subcategories.

In accordance with another aspect of the present disclosure, a computer-implemented method for providing tattoo designs is provided. The method can include displaying a virtual keyboard and receiving at least one character from the virtual keyboard. In addition, the method can include converting the at least one character into multiple fonts and displaying the at least one character in the multiple fonts. The method can also include receiving a selected font for the at least one character from the multiple fonts and printing the at least one character in the selected font as a tattoo design.

In one embodiment, the method can include converting and displaying the at least one character into additional fonts when requested. In one embodiment, the method can include adding graphics to the at least one character and printing the at least one character along with the graphics as the tattoo design. In one embodiment, the graphics can include at least one of a flash image, portfolio image and jewelry image

In accordance with yet another aspect of the present disclosure, a kiosk for facilitating tattoo applications is provided. The kiosk can include a terminal display that provides visual software. In addition, the kiosk can include a data repository that stores, maintains, and delivers a plurality of tattoo designs for display on the terminal display, wherein displaying the plurality of tattoo designs provide a customer with control over a selection and design of their tattoo.

In one embodiment, the plurality of tattoo designs can include at least one of a flash image, portfolio image and jewelry image. In one embodiment, the portfolio image can be separated into a plurality of artists and piercers. In one embodiment, the visual software on the terminal display can provide a sandbox, the sand box allowing the customer to test products and services provided by the kiosk.

In one embodiment, the plurality of tattoo designs for display on the terminal display can be provided through an alpha-menu, wherein the alpha-menu is built by interacting with the data repository. In one embodiment, the data repository can include a data file system and a data request system, wherein the data file system contains a directory structure and the data request system receives instructions from the terminal display, processes the instructions and return data to the terminal display. In one embodiment, the directory structure can include a root directory, category directory and subcategory directory. In one embodiment, the data request system can return alphabetic, category, sub-category, and image/content information in extensible markup language format.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A user computer system having a touch screen, a graphical user interface (GUI) provided on said touch screen, and an interactive viewer displayed through said GUI for determining an appropriate tattoo for an individual, said system comprising:
a database for storing tattoo designs;
at least one processor; and
a memory operatively coupled to said processor, said memory storing program instructions that when executed by said processor, causes said processor to:
receive input using said interactive viewer through said touch screen;
identify at least one tattoo design from said database using said input;
display said at least one tattoo design on said interactive viewer through said GUI;
receive a selection to print said at least one tattoo design;
print said at least one tattoo design.

2. The user computer system of claim 1, wherein said tattoo designs comprise at least one of an illustration, picture, graphic and lettering.

3. The user computer system of claim 1, wherein receiving said input through said touch screen comprises obtaining a text along with a font.

4. The user computer system of claim 3, wherein displaying said at least one tattoo design comprises providing said text in said font on said GUI.

5. The user computer system of claim 1, wherein identifying said at least one tattoo design using said input comprises obtaining a category from said user input and searching through said tattoo designs within said database that fit within said category.

6. The user computer system of claim 5, comprising obtaining a subcategory associated with said category and searching through said tattoo designs within said database that fit within said subcategory.

7. The user computer system of claim 1, wherein said printed tattoo design is provided as a template, said template used by a tattoo artist to apply said at least one tattoo design on a user.

8. The user computer system of claim 1, wherein said tattoo designs are stored within said database in categories and subcategories.

9. A computer-implemented method for providing tattoo designs comprising:
displaying a virtual keyboard;
receiving at least one character from said virtual keyboard;
converting said at least one character into multiple fonts;
displaying said at least one character in said multiple fonts;
receiving a selected font for said at least one character from said multiple fonts; and
printing said at least one character in said selected font as a tattoo design.

10. The computer-implemented method of claim 9, comprising converting and displaying said at least one character into additional fonts when requested.

11. The computer-implemented method of claim 9, comprising adding graphics to said at least one character and printing said at least one character along with said graphics as said tattoo design.

12. The computer-implemented method of claim 9, wherein said graphics comprise at least one of a flash image, portfolio image and jewelry image

13. A kiosk for facilitating tattoo applications comprising:
a terminal display that provides visual software; and
a data repository that stores, maintains, and delivers a plurality of tattoo designs for display on said terminal display, wherein displaying said plurality of tattoo designs provide a customer with control over a selection and design of their tattoo.

14. The kiosk of claim 13, wherein said plurality of tattoo designs comprise at least one of a flash image, portfolio image and jewelry image.

15. The kiosk of claim 13, wherein said portfolio image is separated into a plurality of artists and piercers.

16. The kiosk of claim 13, wherein said visual software on said terminal display provides a sandbox, said sand box allowing said customer to test products and services provided by said kiosk.

17. The kiosk of claim 13, wherein said plurality of tattoo designs for display on said terminal display are provided through an alpha-menu, wherein said alpha-menu is built by interacting with said data repository.

18. The kiosk of claim 13, wherein said data repository comprises a data file system and a data request system, wherein said data file system contains a directory structure and said data request system receives instructions from said terminal display, processes said instructions and return data to said terminal display.

19. The kiosk of claim 18, wherein said directory structure comprises a root directory, category directory and subcategory directory.

20. The kiosk of claim 18, wherein said data request system returns alphabetic, category, sub-category, and image/content information in extensible markup language format.
